(19) United States
(12) Patent Application Publication
(10) Pub. No.: US 2006/0083884 A1
(43) Pub. Date: Apr. 20, 2006

(54) Multilayer tube comprising po, adhesive, evoh, pa, and protection layers

(76) Inventor: Cyrielle Cheng, Saint-Jean De Monts (FR)

Correspondence Address: DYKEMA GOSSETT PLLC, Ste. 300, 39577 Woodward Ave., Bloomfield Hills, MI, 48304-2820, US

(21) Appl. No.: 11/253,276

(22) Filed: Oct. 18, 2005

(30) Foreign Application Priority Data
Oct. 19, 2004 (FR) 0411062

(51) Int. Cl. B32B 1/08

(52) U.S. Cl. 428/36.91

(57) ABSTRACT

A multilayer tube that comprises, from the inside to the outside: an inner layer of polyolefin; a first intermediate layer based on adhesive; a second intermediate layer of ethylene vinylidene alcohol; a third intermediate layer of polyamide; and an outer protection layer.

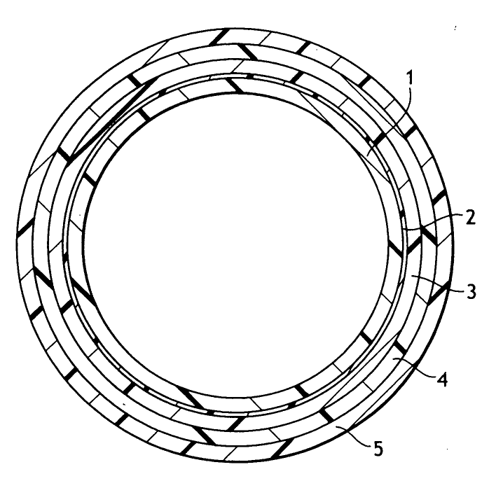

The present invention relates to a multilayer tube, and more particularly a tube for transporting fuel in feed circuits for motor vehicle engines.

### BACKGROUND OF THE INVENTION

Usually, a multilayer tube used for transporting fuel comprises an inner layer of polyamide which possesses relatively good fuel-barrier properties. Nevertheless, polyamides suffer from the drawback of degrading in contact with fuel, thereby releasing oligomers that pollute the fuel and that might damage engine components situated downstream from the tube.

It is also known for multilayer tubes to have an inner layer constituted by a fluorine-containing thermoplastic. Such thermoplastics present good barrier properties. Nevertheless, those materials are quite expensive.

The automotive industry is thus looking for new multilayer tube structures suitable for use in transporting fuel that present low permeability to fuel in order to reduce polluting emissions, while withstanding fuel, and being relatively inexpensive.

### OBJECT OF THE INVENTION

An object of the invention is to satisfy this requirement by proposing a novel structure for a automotive fluid transport tube, and more particularly a fuel transport tube, that is good at withstanding the fluid and presents low permeability in order to reduce polluting emissions, and that is also relatively inexpensive.

### SUMMARY OF THE INVENTION

To this end, the invention provides a multilayer tube that comprises, from the inside to the outside:

an inner layer of polyolefin;

a first intermediate layer based on adhesive;

a second intermediate layer of ethylene vinylidene alcohol;

a third intermediate layer of polyamide; and

an outer protection layer.

The polyolefin layer does not degrade perceptibly in contact with fuel, so that there are no oligomers released into the fluid being transported. The polyolefin layer is also relatively inexpensive. The ethylene-vinylidene-alcohol layer possesses hydrocarbon-barrier properties. This material is also less expensive than the fluorine-based materials used in the past for their barrier function. The polyamide layer presents good chemical resistance and mechanical strength and also possesses relatively low hydrocarbon permeability. The outer layer is arranged to protect the other layers against the external aggression that occurs in the environment in which the tube is used. For automotive use, the outer layer is thus arranged to present good mechanical strength and good chemical resistance to the fluids to be found in the engine environment such as oils, windshield washer liquid, cooling liquid, brake fluid, . . . , and also substances such as zinc chloride or sodium chloride that are used in particular for road maintenance.

Other characteristics and advantages of the invention appear on reading the following description of a particular, non-limiting embodiment of the invention.

### BRIEF DESCRIPTION OF THE DRAWINGS

Reference is made to the sole FIGURE which is a cross-section of a tube in accordance with the invention.

### DETAILED DESCRIPTION OF INVENTION

With reference to the FIGURE, the tube in accordance with the invention comprises, from the inside to the outside:

an inner layer 1;

a first intermediate layer 2;

a second intermediate layer 3;

a third intermediate layer 4; and

a protection layer 5.

The inner layer 1 is made of polyolefin. The inner layer 1 in this case is made of polyethylene, but it could equally well be made of some other polyolefin such as polypropylene or a mixture of polyolefins.

The intermediate layer 2 is made of a binder or adhesive that is compatible with the materials of the inner layer 1 and of the intermediate layer 3. The adhesive used in this example is a mixture of polyolefin and polyamide, such as the product sold under the trademark ORGALLOY by the supplier ATOFINA. In this case, the intermediate layer 1 provides a strong bond between the inner layer 1 and the intermediate layer 3.

The intermediate layer 3 is made of ethylene-vinylidene-alcohol (EVOH).

The intermediate layer 4 is based on polyamide and more particularly in this case on a polyamide 6-12. The polyamide used could also be some other polyamide such as a polyamide 6 or a polyamide 12.

The protection layer 5 in this case is made of a thermoplastic elastomer, and more particularly of a thermoplastic elastomer based on polypropylene and ethylene-propylene-diene monomer (PP-EPDM). The protection layer may also be made of some other material, and in particular of polyester. The polyester used is polybutylene terephthalate, for example. Amongst other materials that are suitable for use in the outer layer, mention can also be made of polyolefins such as polypropylene.

Naturally, the invention is not restricted to the embodiment described and various embodiments can be applied thereto without going beyond the ambit of the invention as defined by the claims.

In particular, an adhesive layer may be disposed between the polyamide layer and the outer protection layer when the stresses to which the tube will be subjected require the bonding between these two layers to be reinforced.

In addition, the outer layer may be made of a material other than those described, and in particular of a thermoplastic elastomer including or constituted by one of the following materials:

polyester-ether;

polyether-ester; and

styrene-ethylene-butylene-styrene (SEBS).

Furthermore, the tube of the invention is not restricted to an automotive application.

What is claimed is:

1. A multilayer tube that comprises, from the inside to the outside:
an inner layer of polyolefin;
a first intermediate layer based on adhesive;
a second intermediate layer of ethylene vinylidene alcohol;
a third intermediate layer of polyamide; and
an outer protection layer.

2. A tube according to claim 1, wherein the polyolefin of the inner layer is polyethylene.

3. A tube according to claim 1, wherein the polyolefin of the inner layer is polypropylene.

4. A tube according to claim 1, wherein the polyamide of the third intermediate layer is polyamide 6 12.

5. A tube according to claim 1, wherein the outer protection layer is made of a thermoplastic elastomer.

6. A tube according to claim 5, wherein the elastomer is based on polypropylene and on ethylene-propylene-diolefin monomer.

7. A tube according to claim 5, wherein the elastomer comprises polyester-ether.

8. A tube according to claim 5, wherein the elastomer comprises polyether-ester.

9. A tube according to claim 5, wherein the elastomer comprises styrene-ethylene-butadene-styrene.

10. A tube according to claim 1, wherein the outer layer is made of polyester.

11. A tube according to claim 10, wherein the polyester is a polybutylene terephthalate.

12. A tube according to claim 1, wherein the outer protection layer is made of polyolefin.

13. A tube according to claim 12, wherein the polyolefin in the outer layer is a polypropylene.
